(19) United States
(12) Patent Application Publication
(10) Pub. No.: US 2021/0099743 A1
(43) Pub. Date: Apr. 1, 2021

(54) PRESENTING CONTENT BASED ON NETWORK BANDWIDTH

(71) Applicant: LENOVO (Singapore) PTE. LTD., New Tech Park (SG)

(72) Inventors: John Carl Mese, Cary, NC (US); Nathan J. Peterson, Oxford, NC (US); Arnold S. Weksler, Raleigh, NC (US); Mark Patrick Delaney, Raleigh, NC (US); Russell Speight VanBlon, Raleigh, NC (US)

(21) Appl. No.: 16/586,501

(22) Filed: Sep. 27, 2019

(51) Int. Cl. H04N 21/24; H04L 12/24; H04L 12/911

(52) U.S. Cl. CPC H04N 21/2402; H04L 47/822; H04L 41/0896

(57) ABSTRACT

Apparatuses, methods, systems, and program products are disclosed for presenting content based on network bandwidth. An apparatus includes a processor and a memory that stores code executable by the processor. The code is executable to determine a content element to be presented from a remote location, determine an amount of network bandwidth that is necessary to present the content element from the remote location, and present the content element in response to the amount of network bandwidth that is necessary to present the content satisfying a predefined network bandwidth.

### FIELD

The subject matter disclosed herein relates to content presentation and more particularly relates to presenting content based on network bandwidth.

### BACKGROUND

Content that is presented on a device, such as in a web browser, may be downloaded or streamed from a remote location, and different content may require different bandwidths to download or stream the content, which may not be compatible or optimal for the network that the device is connected to.

### BRIEF SUMMARY

Apparatuses, methods, systems, and program products are disclosed for presenting content based on network bandwidth. An apparatus, in one embodiment, includes a processor and a memory that stores code executable by the processor. The code, in certain embodiments, is executable to determine a content element to be presented from a remote location, determine an amount of network bandwidth that is necessary to present the content element from the remote location, and present the content element in response to the amount of network bandwidth that is necessary to present the content satisfying a predefined network bandwidth.

A method for presenting content based on network bandwidth, in one embodiment, includes determining a content element to be presented from a remote location, determining an amount of network bandwidth that is necessary to present the content element from the remote location, and presenting the content element in response to the amount of network bandwidth that is necessary to present the content satisfying a predefined network bandwidth.

A program product for presenting content based on network bandwidth, in one embodiment, includes a computer readable storage medium that stores code executable by a processor. In one embodiment, the code is executable by the processor to determine a content element to be presented from a remote location, determine an amount of network bandwidth that is necessary to present the content element from the remote location, and present the content element in response to the amount of network bandwidth that is necessary to present the content satisfying a predefined network bandwidth.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a system for presenting content based on network bandwidth;

FIG. 2 is a schematic block diagram illustrating one embodiment of an apparatus for presenting content based on network bandwidth;

FIG. 3 is a schematic block diagram illustrating one embodiment of another apparatus for presenting content based on network bandwidth;

FIG. 4 is a schematic flow chart diagram illustrating one embodiment of a method for presenting content based on network bandwidth;

FIG. 5 is a schematic flow chart diagram illustrating one embodiment of another method for presenting content based on network bandwidth; and

FIG. 6 is a schematic flow chart diagram illustrating one embodiment of a further method for presenting content based on network bandwidth.

### DETAILED DESCRIPTION

As will be appreciated by one skilled in the art, aspects of the embodiments may be embodied as a system, method or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, comprise one or more physical or logical blocks of executable code which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which comprises one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

Apparatuses, methods, systems, and program products are disclosed for presenting content based on network bandwidth. An apparatus, in one embodiment, includes a processor and a memory that stores code executable by the processor. The code, in certain embodiments, is executable to determine a content element to be presented from a remote location, determine an amount of network bandwidth that is necessary to present the content element from the remote location, and present the content element in response to the amount of network bandwidth that is necessary to present the content satisfying a predefined network bandwidth.

In one embodiment, the code is further executable by the processor to determine a type of the content element and determine the amount of network bandwidth that is necessary to present the content based on the determined type of the content element. In some embodiments, the type of the content element is determined according to one or more of metadata associated with the content element and a dynamic scan of at least a portion of the content element.

In various embodiments, the predefined network bandwidth is one of a plurality of predefined network bandwidths that are each associated with a particular type of content element. In certain embodiments, the predefined network bandwidth is associated with one or more of a user account, a network location, a network connection type, an application, an operating system, a web page, and a device.

In some embodiments, the content element comprises content presented on a social media feed that is hosted by a social media network. In further embodiments, the code is further executable by the processor to determine an order to present a plurality of content on the social media feed according to the network bandwidth that is necessary to present each of the plurality of content elements.

In one embodiment, the code is further executable by the processor to insert a placeholder in the social media feed where the content element would be presented in response to the content element not being presented due to the network bandwidth that is necessary to present the content element not satisfying the predefined network bandwidth, receive input from a user within the placeholder for forcing the content element to be presented in the social feed, and present the content element at a location of the placeholder in response to the received input.

In one embodiment, the code is further executable by the processor to present the content element, even though the amount of network bandwidth that is necessary to present the content element does not satisfy the predefined network bandwidth, in response to one or more characteristics of the content element satisfying one or more exceptions for presenting the content element.

In further embodiments, the one or more characteristics comprises determining one or more of that the content is user-defined content, that the content is ad-supported content, and that the content is uploaded by a known user. In some embodiments, the code is further executable by the processor to prompt a user to define the predefined network bandwidth in response to determining that the predefined network bandwidth is not defined.

In various embodiments, presentation of the content element is further determined based on whether a speed of a network connection with the remote location satisfies a speed threshold. In some embodiments, presentation of the content element is further determined based on whether a load on a network connection satisfies a load threshold.

A method for presenting content based on network bandwidth, in one embodiment, includes determining a content element to be presented from a remote location, determining an amount of network bandwidth that is necessary to present the content element from the remote location, and presenting the content element in response to the amount of network bandwidth that is necessary to present the content satisfying a predefined network bandwidth.

In one embodiment, the method includes determining a type of the content element according to one or more of metadata associated with the content element and a dynamic scan of at least a portion of the content element and determining the amount of network bandwidth that is necessary to present the content based on the determined type of the content element.

In some embodiments, the predefined network bandwidth is associated with one or more of a user account, a network location, a network connection type, an application, an operating system, a web page, and a device. In various embodiments, the content element comprises content presented on a social media feed that is hosted by a social media network.

In one embodiment, the method includes determining an order to present a plurality of content on the social media feed according to the network bandwidth that is necessary to present each of the plurality of content elements. In one embodiment, the method includes presenting the content element, even though the amount of network bandwidth that is necessary to present the content element does not satisfy the predefined network bandwidth, in response to one or more characteristics of the content element satisfying one or more exceptions for presenting the content element.

A program product for presenting content based on network bandwidth, in one embodiment, includes a computer readable storage medium that stores code executable by a processor. In one embodiment, the code is executable by the processor to determine a content element to be presented from a remote location, determine an amount of network bandwidth that is necessary to present the content element from the remote location, and present the content element in response to the amount of network bandwidth that is necessary to present the content satisfying a predefined network bandwidth.

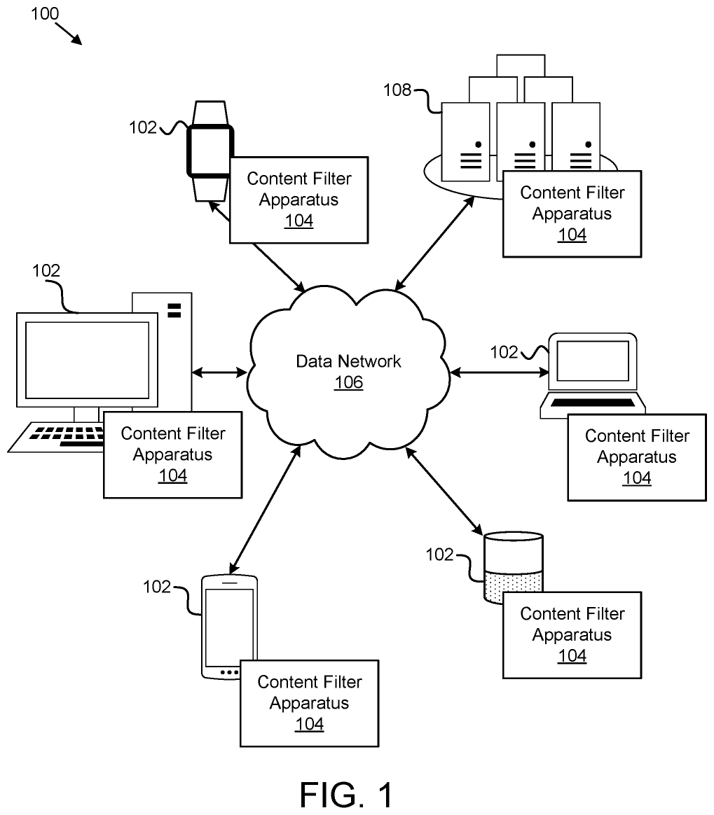

FIG. 1 is a schematic block diagram illustrating one embodiment of a system 100 for presenting content based on network bandwidth. In one embodiment, the system 100 includes one or more information handling devices 102, one or more content filter apparatuses 104, one or more data networks 106, and one or more servers 108. In certain embodiments, even though a specific number of information handling devices 102, content filter apparatuses 104, data networks 106, and servers 108 are depicted in FIG. 1, one of skill in the art will recognize, in light of this disclosure, that any number of information handling devices 102, content filter apparatuses 104, data networks 106, and servers 108 may be included in the system 100.

In one embodiment, the system 100 includes one or more information handling devices 102. The information handling devices 102 may include one or more of a desktop computer, a laptop computer, a tablet computer, a smart phone, a smart speaker (e.g., Amazon Echo®, Google Home®, Apple HomePod®), an Internet of Things device, a security system, a set-top box, a gaming console, a smart TV, a smart watch, a fitness band or other wearable activity tracking device, an optical head-mounted display (e.g., a virtual reality headset, smart glasses, or the like), a High-Definition Multimedia Interface (“HDMI”) or other electronic display dongle, a personal digital assistant, a digital camera, a video camera, or another computing device comprising a processor (e.g., a central processing unit (“CPU”), a processor core, a field programmable gate array (“FPGA”) or other programmable logic, an application specific integrated circuit (“ASIC”), a controller, a microcontroller, and/or another semiconductor integrated circuit device), a volatile memory, and/or a non-volatile storage medium, a display, a connection to a display, and/or the like.

In certain embodiments, the information handling devices 102 are communicatively coupled to one or more other information handling devices 102 and/or to one or more servers 108 over a data network 106, described below. The information handling devices 102, in a further embodiment, may include processors, processor cores, and/or the like that are configured to execute various programs, program code, applications, instructions, functions, and/or the like. The information handling devices 102 may be coupled to one or more display devices, may have one or more integrated display devices, and/or the like. The display devices may include touch displays, televisions, computer monitors, laptop monitors, and/or the like.

In certain embodiments, one or more input devices may be communicatively connected to an information handling device 102. The input devices may include a mouse, a remote control, a gaming controller, a smart phone, a universal remote, and/or the like that is communicatively coupled to an information handling device 102 over a wired (e.g., USB) or wireless (e.g., Bluetooth®, NFC, infrared, Wi-Fi, or the like) connection.

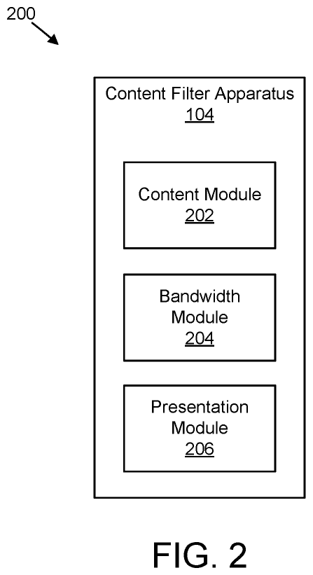

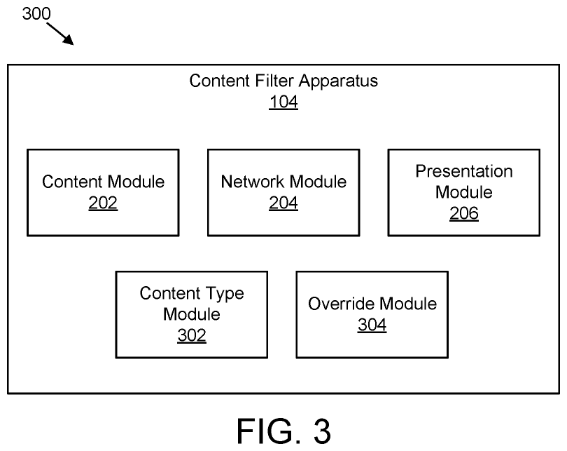

In one embodiment, the content filter apparatus 104 is configured to determine a content element to be presented that is hosted at a remote location, determine an amount of network bandwidth that is necessary to present the content element from the remote location, and present the content element in response to the amount of network bandwidth that is necessary to present the content satisfying a predefined network bandwidth. In this manner, the content filter apparatus 104 can act as a content filter based on the bandwidth requirements of streaming or downloading the content from the remote location, e.g., cloud server, to a user's device. The content filter apparatus 104, including its various sub-modules, may be located on one or more information handling devices 102 in the system 100, one or more servers 108, one or more network devices, and/or the like. The content filter apparatus 104 is described in more detail below with reference to FIGS. 2 and 3.

In various embodiments, the content filter apparatus 104 may be embodied as a hardware appliance that can be installed or deployed on an information handling device 102, on a server 108, on a user's mobile device, on a display, or elsewhere on the data network 106. In certain embodiments, the content filter apparatus 104 may include a hardware device such as a secure hardware dongle or other hardware appliance device (e.g., a set-top box, a network appliance, or the like) that attaches to a device such as a laptop computer, a server 108, a tablet computer, a smart phone, a security system, or the like, either by a wired connection (e.g., a universal serial bus (“USB”) connection) or a wireless connection (e.g., Bluetooth®, Wi-Fi, near-field communication (“NFC”), or the like); that attaches to an electronic display device (e.g., a television or monitor using an HDMI port, a DisplayPort port, a Mini DisplayPort port, VGA port, DVI port, or the like); and/or the like. A hardware appliance of the content filter apparatus 104 may include a power interface, a wired and/or wireless network interface, a graphical interface that attaches to a display, and/or a semiconductor integrated circuit device as described below, configured to perform the functions described herein with regard to the content filter apparatus 104.

The content filter apparatus 104, in such an embodiment, may include a semiconductor integrated circuit device (e.g., one or more chips, die, or other discrete logic hardware), or the like, such as a field-programmable gate array (“FPGA”) or other programmable logic, firmware for an FPGA or other programmable logic, microcode for execution on a microcontroller, an application-specific integrated circuit (“ASIC”), a processor, a processor core, or the like. In one embodiment, the content filter apparatus 104 may be mounted on a printed circuit board with one or more electrical lines or connections (e.g., to volatile memory, a non-volatile storage medium, a network interface, a peripheral device, a graphical/display interface, or the like). The hardware appliance may include one or more pins, pads, or other electrical connections configured to send and receive data (e.g., in communication with one or more electrical lines of a printed circuit board or the like), and one or more hardware circuits and/or other electrical circuits configured to perform various functions of the content filter apparatus 104.

The semiconductor integrated circuit device or other hardware appliance of the content filter apparatus 104, in certain embodiments, includes and/or is communicatively coupled to one or more volatile memory media, which may include but is not limited to random access memory (“RAM”), dynamic RAM (“DRAM”), cache, or the like. In one embodiment, the semiconductor integrated circuit device or other hardware appliance of the content filter apparatus 104 includes and/or is communicatively coupled to one or more non-volatile memory media, which may include but is not limited to: NAND flash memory, NOR flash memory, nano random access memory (nano RAM or “NRAM”), nanocrystal wire-based memory, silicon-oxide based sub-10 nanometer process memory, graphene memory, Silicon-Oxide-Nitride-Oxide-Silicon (“SONOS”), resistive RAM (“RRAM”), programmable metallization cell (“PMC”), conductive-bridging RAM (“CBRAM”), magneto-resistive RAM (“MRAM”), dynamic RAM (“DRAM”), phase change RAM (“PRAM” or “PCM”), magnetic storage media (e.g., hard disk, tape), optical storage media, or the like.

The data network 106, in one embodiment, includes a digital communication network that transmits digital communications. The data network 106 may include a wireless network, such as a wireless cellular network, a local wireless network, such as a Wi-Fi network, a Bluetooth® network, a near-field communication (“NFC”) network, an ad hoc network, and/or the like. The data network 106 may include a wide area network (“WAN”), a storage area network (“SAN”), a local area network (“LAN”), an optical fiber network, the internet, or other digital communication network. The data network 106 may include two or more networks. The data network 106 may include one or more servers, routers, switches, and/or other networking equipment. The data network 106 may also include one or more computer readable storage media, such as a hard disk drive, an optical drive, non-volatile memory, RAM, or the like.

The wireless connection may be a mobile telephone network. The wireless connection may also employ a Wi-Fi network based on any one of the Institute of Electrical and Electronics Engineers (“IEEE”) 802.11 standards. Alternatively, the wireless connection may be a Bluetooth® connection. In addition, the wireless connection may employ a Radio Frequency Identification (“RFID”) communication including RFID standards established by the International Organization for Standardization (“ISO”), the International Electrotechnical Commission (“IEC”), the American Society for Testing and Materials® (ASTM®), the DASH7™ Alliance, and EPCGlobal™

Alternatively, the wireless connection may employ a ZigBee® connection based on the IEEE 802 standard. In one embodiment, the wireless connection employs a Z-Wave® connection as designed by Sigma Designs®. Alternatively, the wireless connection may employ an ANT® and/or ANT+® connection as defined by Dynastream® Innovations Inc. of Cochrane, Canada.

The wireless connection may be an infrared connection including connections conforming at least to the Infrared Physical Layer Specification (“IrPHY”) as defined by the Infrared Data Association® (“IrDA”®). Alternatively, the wireless connection may be a cellular telephone network communication. All standards and/or connection types include the latest version and revision of the standard and/or connection type as of the filing date of this application.

The one or more servers 108, in one embodiment, may be embodied as blade servers, mainframe servers, tower servers, rack servers, and/or the like. The one or more servers 108 may be configured as mail servers, web servers, application servers, FTP servers, media servers, data servers, web servers, file servers, virtual servers, and/or the like. The one or more servers 108 may be communicatively coupled (e.g., networked) over a data network 106 to one or more information handling devices 102.

FIG. 2 is a schematic block diagram illustrating one embodiment of an apparatus 200 for presenting content based on network bandwidth. In one embodiment, the apparatus 200 includes an instance of a content filter apparatus 104. The content filter apparatus 104, in certain embodiments, includes one or more of a content module 202, a bandwidth module 204, and a presentation module 206, which are described in more detail below.

The content module 202, in one embodiment, is configured to determine a content element to be presented. The content element may be hosted at a remote location such as a cloud server, a remote data center, and/or the like. The content element may be a multimedia content element such as a video, an image, an audio file, or the like; a text file; a PDF file; a game; a spreadsheet; and/or other file. The content module 202 may be located on the user's device, such as the user's smart phone or laptop device, and may communicate with the remote device to query for, download, stream, or the like the content element for presentation on the user's device.

For instance, in one embodiment, the content element includes content that is presented on a social media feed on the user's device that is hosted by a social media network such as Facebook®, YouTube®, Instagram®, Twitter®, and/or the like. For example, the content element may be included in individual posts on the social media feed such as a video or image uploaded by a user's friend, ad-supported content that is uploaded by the social media network or an advertiser, and/or the like. Other content may include content on a file-sharing website, a gaming website (e.g., Steam®), a streaming service web site (e.g., Netflix®, Hulu®, or the like), and/or the like.

The bandwidth module 204, in one embodiment, is configured to determine an amount of network bandwidth that is necessary to present the content element from the remote location. Network bandwidth, as used herein, may refer to the capacity of a wired or wireless network communications link to transmit the maximum amount of data from one point to another over a computer network or internet connection in a given amount of time, e.g., one second. Synonymous with capacity, bandwidth describes the data transfer rate, which may be measured in bits per second, kilobits per second, megabits per second, gigabits per second, or the like, for example. Thus, the network bandwidth necessary or required to transmit a content element may be the capacity required to transmit or stream the content element over a network connection between a remote location and the user's device, which may be capped by a link in the network connection that has the lowest capacity.

The network bandwidth may then be dependent on the network infrastructure and the size of the content element (e.g., the number of bytes/bits that comprise the content element and that are transferred over the network connection). If the user has a strong, reliable connection on a fast network (e.g., a Wi-fi or 5G connection), then the bandwidth will be higher than if the user is connected to a weaker, less reliable connection (e.g., a roaming connection, a 3G connection, a weak Wi-Fi signal, or the like).

Furthermore, different content elements may have different sizes. For instance, a video file may have a bigger size than an image file or an audio file. Moreover, a video file may be bigger or smaller than a different video file depending on the resolution, quality, run time, or the like of the video files. For example, a video captured in 4K may have a bigger size than a video captured in 1080p. Also, an image file may have a bigger file size than a video, e.g., if the image has a greater resolution or quality than the video.

The presentation module 206, in one embodiment, is configured to present the content element in response to the amount of network bandwidth that is necessary to present the content satisfying a predefined network bandwidth. The predefined network bandwidth may be a predefined threshold capacity (e.g., megabits per second) of the network connection between the user's device and the remote device. The predefined network bandwidth may be set by a user, may be determined dynamically based on the capacity of the network connection between the user's device and the remote location, may be based on a predefined amount of time for loading a content element (e.g., the max amount of time that a user wants to wait for a content element to load such as two-three seconds, for example), and/or the like.

In one embodiment, the predefined network bandwidth may be associated or assigned to a user account such as a Google® account, and Apple® account, a Facebook® account, an Instagram® account, a YouTube® account, a Microsoft® account, or the like so that the predefined network bandwidth can be accessed regardless the device that the user is using. In other words, the predefined network bandwidth can be associated with a user account such that the predefined network bandwidth can be accessed wherever the user logs into his/her account.

In further embodiments, the predefined network bandwidth may be associated with or assigned to a network location (e.g., a home network, an office network, or the like) and/or a network connection type (e.g., a Wi-Fi network, a cellular 4G or 5G network, or the like) such that when a device is connected to the network, the predefined network bandwidth for the network applies. The predefined network bandwidth may be associated with or assigned to a specific application (e.g., Google Chrome®, Internet Explorer®, or the like) or application type (e.g., a web browser application), an operating system (e.g., Microsoft Windows®) such that when the specific application or application type is executed, the predefined network bandwidth for the application/application type is applied regardless the network that the application is using. The predefined network bandwidth may be associated with or assigned to a particular device (e.g., a user's specific smart phone or laptop computer) so that when the particular device is used, regardless the network that it is connected to, the predefined network bandwidth applies. In further embodiments, the predefined network bandwidth may be associated with a web page/website and/or mobile application such as Facebook®, Twitter®, Instagram®, or the like such that when the website or mobile application is accessed or used, regardless the network that it is connected to, the predefined network bandwidth applies.

If multiple predefined network bandwidths have been set at different levels, e.g., at the network, application, operating system, and/or device level, the presentation module 206 may select the predefined network bandwidth that is the greatest or the smallest, may take an average of the predefined network bandwidths, may assign a priority to each predefined network bandwidth (e.g., based on user input, based on a configuration file, or the like), and/or the like.

In one embodiment, if the network bandwidth that is necessary or required to present the content element (e.g., to transmit, download, or stream the content element) satisfies the predefined network bandwidth (e.g., is less than or equal to), then the presentation module 206 may present the content element, or allows the content element to be presented. In some embodiments, based on the network bandwidth that is necessary to present the content element, the presentation module 206 determines an order to present the content element among a plurality of different content elements.

For instance, if the content element is a post on a social media feed, the content element may be presented in a lower order if it has a higher network bandwidth requirement than a different content element. For example, if the content element is an image file, it may be presented near the top of the social media feed whereas a post containing a video file may be presented in a lower position relative to the image file because the video file may require a higher network bandwidth to stream the video on the social media feed.

In one embodiment, if a predefined network bandwidth has not been set, at any level, the presentation module 206 may prompt a user to set the predefined network bandwidth, may use a default network bandwidth, may use an average network bandwidth (e.g., average of network bandwidths that that the device has been connected to previously), may use the maximum or minimum network bandwidth of the current network that the device is connected to, and/or the like.

In further embodiments, the presentation module 206 may consider other network characteristics to determine whether to present the content element. For instance, the presentation module 206 may present the content element in response to a speed of the network connection between the user's device and the remote location satisfying (e.g., being greater than or equal to) a speed threshold (e.g., in terms of kilobits per second, megabits per second, or the like). In another example, the presentation module 206 may present the content element in response to a load on a network connection satisfying (e.g., being less than or equal to) a load threshold (e.g., an amount of traffic on the network).

FIG. 3 is a schematic block diagram illustrating one embodiment of another apparatus 300 for presenting content based on network bandwidth. In one embodiment, the apparatus 300 includes an instance of a content filter apparatus 104. The content filter apparatus 104, in certain embodiments, includes one or more of a content module 202, a bandwidth module 204, and a presentation module 206, which may be substantially similar to the content module 202, the bandwidth module 204, and the presentation module 206 described above with reference to FIG. 2. In further embodiments, the content filter apparatus 104 includes one or more of a content type module 302 and an override module 304, which are described in more detail below.

In one embodiment, the content type module 302 is configured to determine a type of the content element and determine the amount of network bandwidth that is necessary to present the content based on the determined type of the content element. The type of the content element may be based on a file extension such as .mkv or .mp4 for video files, a .mp3 for audio files, and a .jpeg for image files. The content type may provide an estimate or forecast on the amount of network bandwidth will be necessary to transmit the content element.

In certain embodiments, the type of the content element is determined according to one or more of metadata associated with the content element and a dynamic scan of at least a portion of the content element. Metadata may include a file extension, a description of the file, a structure of the file, a resolution, a quality, a file size, a file name, and/or the like. A dynamic scan of the file may include downloading or streaming a portion of the file to be analyzed, or analyzing at least a portion of the file at the remote location, to determine various characteristics of the file such as a resolution of the file, a quality of the file, and/or the like, which may be indicative of an amount of network bandwidth that will be required to transmit and present the full file.

In certain embodiments, the predefined network bandwidth is associated with a particular content type. For instance, a video file may be allowed a greater bandwidth threshold than an image because videos typically have bigger file sizes than images. Thus, images, audio files, and/or videos may each have different predefined network bandwidths for defining which images, audio files, and/or videos can be presented on the user's device.

In one embodiment, the override module 304 is configured to check one or more rules or exceptions to the predefined network bandwidth and allow the content element to be presented even though the amount of network bandwidth that is necessary to present the content element does not satisfy the predefined network bandwidth, in response to one or more characteristics of the content element satisfying one or more exceptions for presenting the content element.

For instance, if the content element is a social media post by a user's family or friend, then the content element may be allowed to be presented even if the content element does not satisfy the predefined network bandwidth. Similarly, if the content element is a video or image associated with a subject or person that the user likes to follow or has designated as an exception to the predefined network bandwidth rules, then the override module 304 may allow the content element to be presented.

On the other hand, if the content element has characteristics that a user has defined for not allowing the content element to be presented, even though the content element satisfies the predefined network bandwidth, then the override module 304 may prevent the content element to be presented. For instance, if a user has defined a rule to prevent any ad-supported posts to be presented in their social media feed, such as a video for an advertisement, even if the ad-supported post satisfies the predefined network bandwidth, the override module 304 may prevent the ad-supported post from being presented in the user's social media feed.

In further embodiments, the override module 304 is configured to insert a placeholder in the social media feed where the content element would be presented in response to the content element not being presented due to the network bandwidth that is necessary to present the content element. For instance, if a video post in the user's social media feed does not satisfy the predefined network bandwidth for the social media feed, then the override module 304 may insert a placeholder in the social media feed where the video would otherwise have been located to let the user know that the video post did not meet the predefined network bandwidth requirements.

In one embodiment, the override module 304 may receive input from a user within the placeholder, e.g., a mouse click or touch within the placeholder, for forcing the content element to be presented in the social feed. For example, the override module 304 may present a pop-up window or menu in response to the user's input to present an option for the user to force presentation of the content element that did not meet the predefined network bandwidth requirement. Accordingly, in response to the user input, the override module 304 may present, or may allow to be presented, the content element at a location of the placeholder.

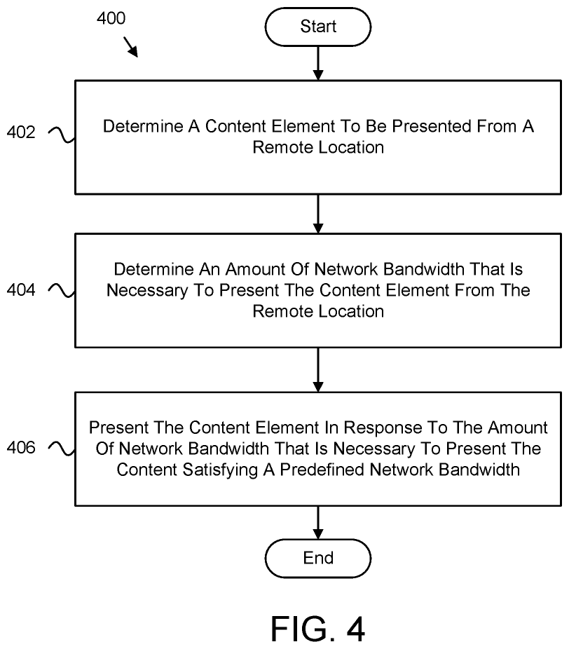

FIG. 4 is a schematic flow chart diagram illustrating one embodiment of a method 400 for presenting content based on network bandwidth. In one embodiment, the method 400 begins and determines 402 a content element to be presented that is hosted at a remote location. In further embodiments, the method 400 determines 404 an amount of network bandwidth that is necessary to present the content element from the remote location. In some embodiments, the method 400 presents 406 the content element in response to the amount of network bandwidth that is necessary to present the content satisfying a predefined network bandwidth, and the method ends. In one embodiment, the content module 202, the network module 204, and the presentation module 206 perform the various steps of the method 400.

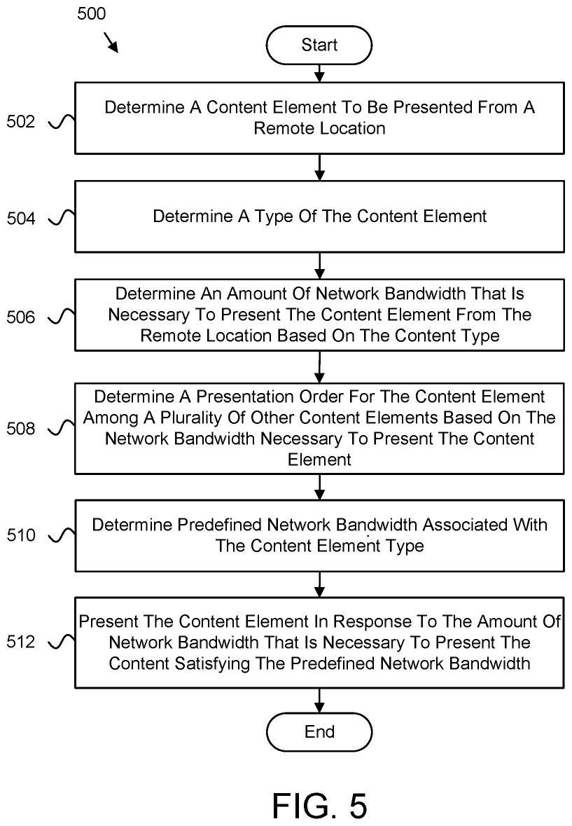

FIG. 5 is a schematic flow chart diagram illustrating one embodiment of another method 500 for presenting content based on network bandwidth. In one embodiment, the method 500 begins and determines 502 a content element to be presented from a remote location. In some embodiments, the method 500 determines 504 a type of the content element.

In one embodiment, the method 500 determines 506 an amount of network bandwidth that is necessary to present the content element from the remote location based on the content type. In certain embodiments, the method 500 determines 508 a presentation order for the content element among a plurality of other content elements based on the network bandwidth necessary to present the content element.

In one embodiment, the method 500 determines 510 a predefined network bandwidth associated with the content element type. In various embodiments, the method 500 presents 512 the content element in response to the amount of network bandwidth that is necessary to present the content satisfying the predefined network bandwidth, and the method 500 ends. In one embodiment, the content module 202, the network module 204, the presentation module 206, and the content type module 302 perform the various steps of the method 500.

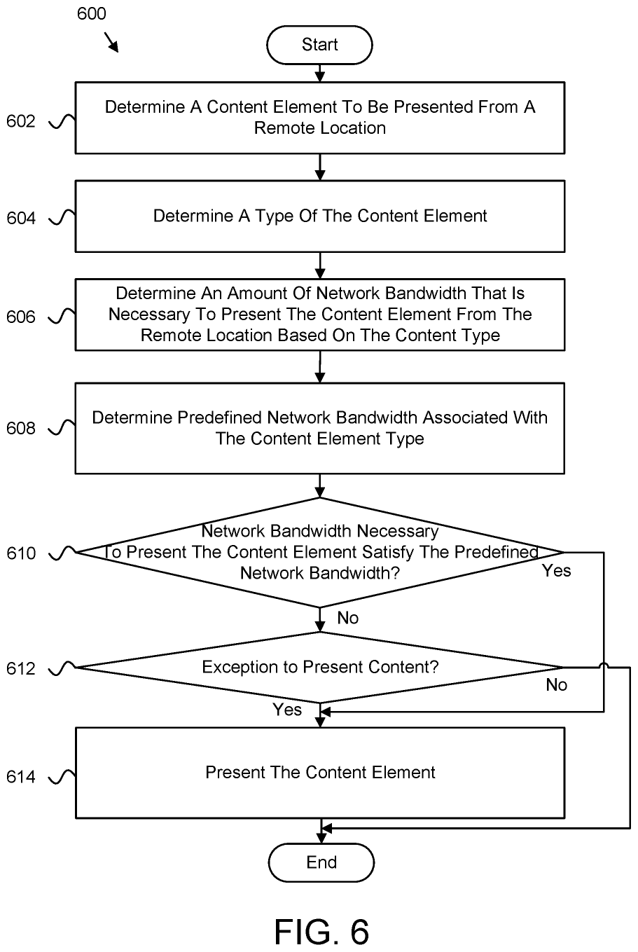

FIG. 6 is a schematic flow chart diagram illustrating one embodiment of a further method 600 for presenting content based on network bandwidth. In one embodiment, the method 600 begins and determines 602 a content element to be presented from a remote location. In some embodiments, the method 600 determines 604 a type of the content element.

In one embodiment, the method 600 determines 606 an amount of network bandwidth that is necessary to present the content element from the remote location based on the content type. In one embodiment, the method 600 determines 608 a predefined network bandwidth associated with the content element type.

In one embodiment, the method 600 determines 610 whether the amount of network bandwidth that is necessary to present the content element from the remote location satisfies the predefined network bandwidth. If so, then the method 600 presents 614 the content element, and the method 600 ends.

Otherwise, if not, the method 600 determines 612 whether there is an exception for overriding the predefined network bandwidth based on the characteristics of the content element. If so, then then method 600 presents 614 the content element, and the method 600 ends. In one embodiment, the content module 202, the network module 204, the presentation module 206, the content type module 302, and the override module 304 perform the various steps of the method 600.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus comprising:
a processor; and
a memory that stores code executable by the processor to:
determine a content element to be presented, the content element hosted at a remote location;
determine an amount of network bandwidth that is necessary to present the content element from the remote location; and
present the content element in response to the amount of network bandwidth that is necessary to present the content satisfying a predefined network bandwidth.

2. The apparatus of claim 1, wherein the code is further executable by the processor to:
determine a type of the content element; and
determine the amount of network bandwidth that is necessary to present the content based on the determined type of the content element.

3. The apparatus of claim 2, wherein the type of the content element is determined according to one or more of metadata associated with the content element and a dynamic scan of at least a portion of the content element.

4. The apparatus of claim 2, wherein the predefined network bandwidth is one of a plurality of predefined network bandwidths that are each associated with a particular type of content element.

5. The apparatus of claim 1, wherein the predefined network bandwidth is associated with one or more of a user account, a network location, a network connection type, an application, an operating system, a web page, and a device.

6. The apparatus of claim 1, wherein the content element comprises content presented on a social media feed that is hosted by a social media network.

7. The apparatus of claim 6, wherein the code is further executable by the processor to determine an order to present a plurality of content on the social media feed according to the network bandwidth that is necessary to present each of the plurality of content elements.

8. The apparatus of claim 6, wherein the code is further executable by the processor to:
insert a placeholder in the social media feed where the content element would be presented in response to the content element not being presented due to the network bandwidth that is necessary to present the content element not satisfying the predefined network bandwidth;
receive input from a user within the placeholder for forcing the content element to be presented in the social feed; and
present the content element at a location of the placeholder in response to the received input.

9. The apparatus of claim 1, wherein the code is further executable by the processor to present the content element, even though the amount of network bandwidth that is necessary to present the content element does not satisfy the predefined network bandwidth, in response to one or more characteristics of the content element satisfying one or more exceptions for presenting the content element.

10. The apparatus of claim 9, wherein the one or more characteristics comprises determining one or more of that the content is user-defined content, that the content is ad-supported content, and that the content is uploaded by a known user.

11. The apparatus of claim 1, wherein the code is further executable by the processor to prompt a user to define the predefined network bandwidth in response to determining that the predefined network bandwidth is not defined.

12. The apparatus of claim 1, wherein presentation of the content element is further determined based on whether a speed of a network connection with the remote location satisfies a speed threshold.

13. The apparatus of claim 1, wherein presentation of the content element is further determined based on whether a load on a network connection satisfies a load threshold.

14. A method comprising:
determining, by a processor, a content element to be presented, the content element hosted at a remote location;
determining an amount of network bandwidth that is necessary to present the content element from the remote location; and
presenting the content element in response to the amount of network bandwidth that is necessary to present the content satisfying a predefined network bandwidth.

15. The method of claim 14, further comprising:
determining a type of the content element, the type determined according to one or more of metadata associated with the content element and a dynamic scan of at least a portion of the content element; and
determining the amount of network bandwidth that is necessary to present the content based on the determined type of the content element.

16. The method of claim 14, wherein the predefined network bandwidth is associated with one or more of a user account, a network location, a network connection type, an application, an operating system, a web page, and a device.

17. The method of claim 14, wherein the content element comprises content presented on a social media feed that is hosted by a social media network.

18. The method of claim 17, further comprising determining an order to present a plurality of content on the social media feed according to the network bandwidth that is necessary to present each of the plurality of content elements.

19. The method of claim 14, further comprising presenting the content element, even though the amount of network bandwidth that is necessary to present the content element does not satisfy the predefined network bandwidth, in response to one or more characteristics of the content element satisfying one or more exceptions for presenting the content element.

20. A program product comprising a computer readable storage medium that stores code executable by a processor, the executable code comprising code to:
determine a content element to be presented, the content element hosted at a remote location;
determine an amount of network bandwidth that is necessary to present the content element from the remote location; and
present the content element in response to the amount of network bandwidth that is necessary to present the content satisfying a predefined network bandwidth.
